(19) United States
(12) Patent Application Publication
(10) Pub. No.: US 2007/0143304 A1
(43) Pub. Date: Jun. 21, 2007

(54) ELECTRIC DEVICE WITH WIRELESS COMMUNICATION MODULE

(75) Inventor: Ju-Young MIN, Kyungsangnam-do (KR)

Correspondence Address: FISH & RICHARDSON P.C., P.O. BOX 1022, MINNEAPOLIS, MN, 55440-1022, US

(73) Assignee: LG ELECTRONICS INC., Seoul (KR)

(21) Appl. No.: 11/552,584

(22) Filed: Oct. 25, 2006

(30) Foreign Application Priority Data
Dec. 12, 2005 (KR) 10-2005-0122051

(51) Int. Cl. G06F 17/30

(52) U.S. Cl. 707/10

(57) ABSTRACT

The present invention discloses an electric device with a wireless communication module which receives weather information through a pager network, calculates well-being indexes from the weather information, and provides the well-being indexes to the user in a real time. The electric device with the wireless communication module includes a pager receiving module for receiving weather information signals through a pager network, and demodulating weather information from the weather information signals, a display means for displaying the weather information or well-being indexes relating to the weather information, a storing means for storing well-being index calculation data for calculating the well-being indexes from the weather information, and a control means for performing an intrinsic function of the electric device, receiving the weather information from the pager receiving module, reading the well-being index calculation data, calculating the well-being indexes according to the well-being index calculation data, and displaying at least one of the weather information and the well-being indexes on the display means.

### TECHNICAL FIELD

The present invention relates to an electric device, and more particularly, to an electric device with a wireless communication module which receives weather information through a pager network, calculates well-being indexes from the weather information, and provides the well-being indexes to the user in a real time.

### BACKGROUND ART

Well-being literally means a healthy comfortable satisfactory living. This lifestyle coming into vogue in USA has been firstly introduced by foreign license woman magazines, and has been more popular by other media.

According to a dictionary definition, well-being means happiness and welfare. It emphasizes quality of life. The well-being group that is a neologism derived from well-being takes a lifestyle maintaining a healthy mind and body as an index of happiness, not a lifestyle pursuing physical values and reputation.

As the middle and upper class people upholding the antiwar movement and the civil right movement in USA accepted naturalism and new age culture against the highly-advanced civilization, well-being emerged as a lifestyle.

As a part of this lifestyle, there is a growing interest in health. For a healthy life, it is necessary to provide information for activities and living on the basis of an indoor or outdoor temperature and/or humidity. Such information includes a food poisoning index and a deterioration index.

The food poisoning index will now be explained. The food poisoning is ‘a kind of sickness by ingestion of food’. Mechanical and physical sickness by ingestion of alien substances does not belong to the food poisoning. Generally, the food poisoning means ‘sickness by microorganisms bonded to food or mixed or residual toxic substances’. The food poisoning index is a ratio of a time causing the food poisoning in the optimum conditions to a time causing the food poisoning at each temperature.

The deterioration index will now be explained. Deterioration of materials is dependent upon a chemically biologically complicated process. It is difficult to define deterioration of materials simply with weather elements. Nevertheless, the temperature and humidity considerably influence deterioration of materials. For example, both chemical corrosion rusting iron and organic deterioration growing molds need the humid air. When relative humidity is below 65%, deterioration does not occur or is very slow. When the relative humidity exceeds 65% and the temperature rises, deterioration is very fast. The deterioration index shows the degree of deterioration.

Hereinafter, the food poisoning index and the deterioration index are defined as well-being indexes.

To obtain the well-being indexes, the user must additionally buy a device for measuring the temperature and/or humidity and calculating the well-being indexes from the temperature and/or humidity.

### DISCLOSURE OF THE INVENTION

The present invention is achieved to solve the above problems. An object of the present invention is to provide an electric device with a wireless communication module which is installed in a house or office, for calculating well-being indexes according to weather information signals received through a pager network, and providing the well-being indexes to the user in a real time.

Another object of the present invention is to provide an electric device with a wireless communication module which is installed in a house or office, for calculating and displaying well-being indexes without incurring additional expenses.

Yet another object of the present invention is to provide an electric device with a wireless communication module which calls the user's attention by visibly and/or audibly providing well-being indexes.

In order to achieve the above-described objects of the invention, there is provided an electric device with a wireless communication module, including: a pager receiving module for receiving weather information signals through a pager network, and demodulating weather information from the weather information signals; a display means for displaying the weather information or well-being indexes relating to the weather information; a storing means for storing well-being index calculation data for calculating the well-being indexes from the weather information; and a control means for performing an intrinsic function of the electric device, receiving the weather information from the pager receiving module, reading the well-being index calculation data, calculating the well-being indexes according to the well-being index calculation data, and displaying at least one of the weather information and the well-being indexes on the display means.

Preferably, the well-being indexes include at least one of a food poisoning index, a food poisoning degree corresponding to the food poisoning index, and an estimated deterioration time.

Preferably, the well-being indexes include at least one of a deterioration index, and a deterioration degree corresponding to the deterioration index.

Preferably, the control means divides range of the well-being indexes into a few stages, and displays the stage corresponding to the well-being indexes on the display means.

Preferably, the display means includes a visible display unit and an audible output unit.

Preferably, the electric device includes a switch for selecting calculation and display of the well-being indexes, and the control means calculates and displays the well-being indexes according to selection of the switch.

Preferably, the electric device is an information home appliance such as a refrigerator and an air-conditioner.

According to another aspect of the present invention, there is provided an electric device with a wireless communication module, including: a pager receiving module for receiving weather information signals through a pager network, and demodulating weather information from the weather information signals; and a control module for controlling the electric device and displaying the state of the electric device, the control module including an operation unit for calculating well-being indexes from the weather information according to well-being index calculation data, and a display unit for displaying at least one of the weather information and the well-being indexes.

### BRIEF DESCRIPTION OF THE DRAWINGS

The present invention will become better understood with reference to the accompanying drawings which are given only by way of illustration and thus are not limitative of the present invention, wherein:

FIG. 1 is a block diagram illustrating an electric device with a wireless communication module in accordance with the present invention;

FIG. 2 is a structure diagram illustrating one example of the electric device of FIG. 1;

FIG. 3 is a flowchart showing a process for displaying well-being indexes in the electric device with the wireless communication module in accordance with the present invention; and

FIG. 4 is an exemplary diagram illustrating weather information and well-being indexes displayed on a display means of FIG. 2.

### BEST MODE FOR CARRYING OUT THE INVENTION

The present invention will now be described in detail on the basis of preferred embodiments and accompanying drawings. However, it is recognized that the scope of the present invention should not be limited to these embodiments and drawings but to the claims as hereinafter recited.

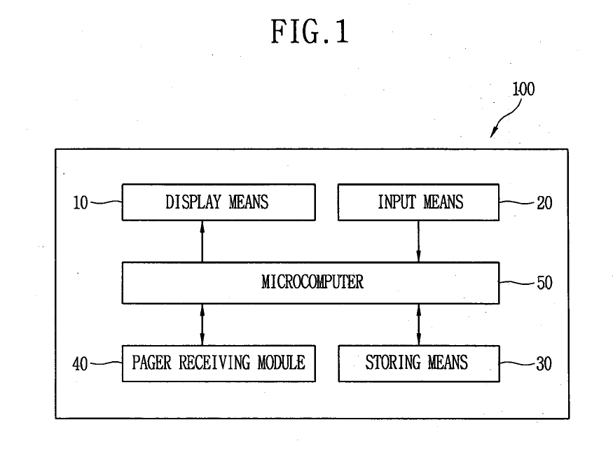

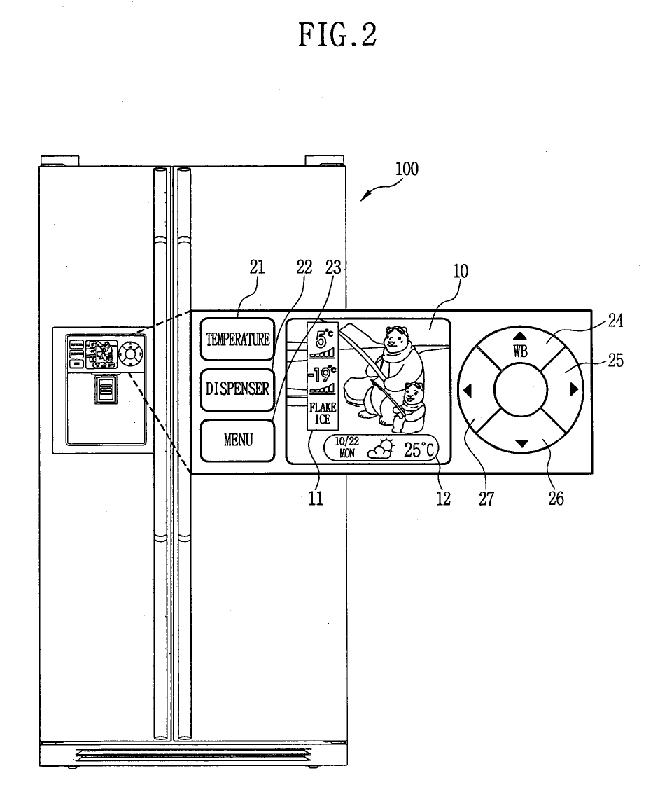

FIG. 1 is a block diagram illustrating an electric devices with a wireless communication module in accordance with the present invention, and FIG. 2 is a structure diagram illustrating one example of the electric device of FIG. 1.

A refrigerator is exemplified as the electric device with the wireless communication module. The present invention can also be applied to the other information home appliances (air-conditioner, microwave oven, washing machine, etc.).

As illustrated in FIGS. 1 and 2, the refrigerator 100 includes a display means 10 for displaying a user interface, weather information, well-being indexes and a standby screen according to standby screen information (for example, information which includes an avatar or basic information such as a set temperature of a freezing chamber, a set temperature of a refrigerating chamber and a service type of a dispenser and which may include the weather information), an input means 20 for receiving a command from the user, a storing means 30 for storing the user interface, the standby screen information, the weather information, and well-being index calculation data for calculating the well-being indexes from the weather information, a pager receiving module 40 for receiving weather information signals from an external source, and demodulating the weather information from the weather information signals, and a microcomputer 50 for receiving the weather information from the pager receiving module 40, reading the well-being index calculation data from the storing means 30, and displaying the well-being indexes on the display means 10. The refrigerator 100 can further include a main microcomputer (not shown) for performing freezing and refrigerating control operations. A communication line is connected between the main microcomputer and the microcomputer 50 for data communication. On the other hand, the refrigerator 100 can perform freezing and refrigerating control operations through the microcomputer 50. In addition, the refrigerator 100 includes a power supply means (not shown) for supplying power to each element.

In detail, the display means 10 is a color TFT LCD for displaying the user interface, the standby screen, the weather information and the well-being indexes. The user interface can be a background displaying an avatar. Also, the user interface can further display the state information of the refrigerator 100 simultaneously with or individually from the avatar (refer to FIG. 2). As shown in FIG. 2, the display means 10 displays the avatar (bear), the basic information 11 of the refrigerator 100 and the weather information 12 (or weather condition of the day) as the standby screen. Display of the well-being indexes will be explained later. Here, the display means 10 includes a visible display unit (not shown) for visibly displaying information, and an audible output unit (not shown) for audibly outputting information or warning.

The input means 20 is not only a means for controlling the general operation of the refrigerator 100, but also a means for receiving a user input for selecting the avatar, displaying the weather information, requesting the well-being indexes (display request), and setting an area code of the pager receiving module 40, and transmitting a proper command to the microcomputer 50. The input means 20 can be formed in a button type, a touch pad type or an electrostatic type.

Still referring to FIG. 2, the input means 20 includes a temperature setting means 21 for setting the temperature of the freezing chamber and the temperature of the refrigerating chamber, a dispenser setting means 22 for setting the service type of the dispenser (cube type ice, water, flake ice, etc.), a menu means 23 for activating and selecting the user interface displayed on the display means 10, a well-being index requesting means 24 for calculating the well-being indexes from the weather information and displaying the well-being indexes, and means 25, 26 and 27 for selecting other functions (activation of a mike, activation of an indoor lamp of the refrigerator 100 and locking of the input means 20). Here, the well-being index requesting means 24 can be selected by the user interface activated by the menu means 23.

The storing means 30 stores the user interface for controlling the general refrigerator operations, the standby screen information, the weather information, the well-being index calculation data and the calculated well-being indexes. As shown in FIG. 2, the standby screen information includes the avatar that is a background image and the basic information 11 of the refrigerator 100. In the standby mode, the microcomputer 50 reads and displays the standby screen information. In addition, still referring to FIG. 2, the standby screen information can include the weather information 12.

The weather information stored in the storing means 30 includes weather forecast information, and weather condition information measured or observed in regard to a generated atmospheric phenomenon. The weather forecast information includes future weather condition information obtained on the basis of a weather chart or other data. The weather condition (or weather) means various atmospheric phenomena. The detailed range (factors) of the atmospheric phenomena includes pressure, temperature (highest temperature, lowest temperature, average temperature, etc.), wet-bulb temperature, steam pressure, dew point temperature, relative humidity, wind direction, wind velocity, precipitation, cloud, evaporation loss, sunshine duration, solar radiation, rainfall frequency, and other phenomena. In accordance with the present invention, the weather information demodulated from the weather information signals can include the atmospheric phenomena of the following Table 1.

TABLE 1

| Weather condition (information) | Explanation |
|---|---|
| Current temperature | Current temperature in specific areas |
| Estimated highest/lowest temperature of next 5 | Estimated temperature and estimated rainfall |
| days | |
| Estimated weather of next 5 days | Cloudy, rainy, snowy, windy, etc. |
| Wind velocity of next 5 days | Average wind velocity (mph) |
| Wind direction of next 5 days | Wind direction |
| Wave height | Wave height in specific areas |
| Effective temperature | Factors by wind velocity, UV and humidity |
| Highest/lowest effective temperature of next 5 | Factors by wind velocity, UV and humidity |
| days | |
| UV index of next 5 days | UV index |
| Humidity of next 5 days | Humidity |
| Precipitation | Current total precipitation (mm, inch) |
| Current visibility | Visible distance (km, mile) |
| Pressure | Mercury pressure |

On the other hand, the well-being index calculation data stored in the storing means 30 are data for calculating a food poisoning index and a deterioration index by using temperature and/or humidity as parameters. The well-being index calculation data include a food poisoning degree corresponding to the food poisoning index and/or an estimated deterioration time, and a deterioration degree corresponding to the deterioration index.

Table 2 shows the well-being index calculation data for the food poisoning index.

TABLE 2

| | Growth | | Food | Food |
|---|---|---|---|---|
| Temperature | speed | Multiplication | poisoning | poisoning |
| (° C.) | (hr⁻¹) | time (hr) | causing time (hr) | index |
| 40 | 1.98 | 0.35 | 3.5 | 100 |
| 39 | 1.95 | 0.36 | 3.6 | 98 |
| 38 | 1.92 | 0.36 | 3.6 | 97 |
| 37 | 1.85 | 0.37 | 3.7 | 93 |
| 36 | 1.8 | 0.39 | 3.9 | 91 |
| 35 | 1.7 | 0.41 | 4.1 | 86 |
| 34 | 1.6 | 0.43 | 4.3 | 81 |
| 33 | 1.45 | 0.48 | 4.8 | 73 |
| 32 | 1.35 | 0.51 | 5.1 | 68 |
| 31 | 1.2 | 0.58 | 5.8 | 61 |
| 30 | 1.05 | 0.66 | 6.6 | 53 |
| 29 | 1 | 0.69 | 6.9 | 51 |
| 28 | 0.9 | 0.77 | 7.7 | 45 |
| 27 | 0.8 | 0.87 | 8.7 | 40 |
| 26 | 0.7 | 0.99 | 9.9 | 35 |
| 25 | 0.6 | 1.16 | 11.6 | 30 |
| 24 | 0.55 | 1.26 | 12.6 | 28 |
| 23 | 0.475 | 1.46 | 14.6 | 24 |
| 22 | 0.4 | 1.73 | 17.3 | 20 |
| 21 | 0.35 | 1.98 | 19.8 | 18 |
| 20 | 0.25 | 2.77 | 27.7 | 13 |
| 19 | 0.2 | 3.47 | 34.7 | 10 |
| 18 | 0.18 | 3.85 | 38.5 | 9 |
| 17 | 0.15 | 4.62 | 46.2 | 8 |
| 16 | 0.12 | 5.78 | 57.8 | 6 |
| 15 | 0.1 | 6.93 | 69.3 | 5 |

Range of the food poisoning index can be divided into four stages according to its size. Table 3 shows the food poisoning degree and/or the estimated deterioration time corresponding to the food poisoning indexes.

TABLE 3

| Index range | Notices |
|---|---|
| Over 86 | Deteriorated within 3 to 4 hours, Very careful |
| | handling of food is needed, High possibility |
| | of food poisoning |
| 50–85 | Deteriorated within 4 to 6 hours, Careful handling |
| | of cooking utensils is needed, Relatively high possibility |
| | of food poisoning |
| 35–50 | Possibility of food poisoning within 6 to 11 |
| | hours, Beware of food poisoning |
| 10–35 | Possibility of food poisoning, Careful handling of |
| | food is needed |

The deterioration index is calculated on the basis of the well-being index calculation data of the following formula 1:

$$DI = \frac{( H - 65 ) {( 1.054 )}^{t}}{14} \qquad Formula 1$$

Here, ‘H’ represents daily average relative humidity (%) and ‘t’ represents daily average temperature (° C).

Range of the deterioration index is divided into three stages according to its size. Table 4 shows the resultant deterioration degree.

TABLE 4

| Deterioration index | Degree |
|---|---|
| 0~3 | Slightly deteriorated |
| 3~7 | Deteriorated |
| 7~10 | Seriously deteriorated |

The storing means 30 further stores a user request data including selection of calculation and display of the well-being indexes, and the microcomputer 50 calculates and displays the well-being indexes according to the data. The user request data can be set and changed by the user input from the input means 20.

The pager receiving module 40 receives data through the pager network. The data are the weather information signals coded to have the weather information. The pager receiving module 40 receives the weather information signals having a relatively small size. The pager receiving module 40 can be connected to the microcomputer 50 by a connector as a single component, or mounted on a single substrate including the microcomputer 50. The pager receiving module 40 demodulates the weather information signals and transmits the weather information to the microcomputer 50. Preferably, even if the pager receiving module 40 is not mounted, the microcomputer 50 can normally perform other functions. The pager receiving module 40 can receive only the weather information signals corresponding to a specific area code, by receiving an identifiable area code and performing area setting (for example, by activating the user interface for area code or area setting by the input means 20). A general receiver for receiving data through the pager network can be used as the pager receiving module 40.

The microcomputer 50 reads the standby screen information including the avatar selected by the user or the automatically-set (default) avatar and the basic information 11 of the refrigerator 100 from the storing means 40, and displays the standby screen on the display means 10 (refer to FIG. 2).

In addition, the microcomputer 50 stores the weather information 12 in the storing means 30 or displays the weather information 12 on the displays means 10 through the pager receiving module 40.

In the standby mode in which the user does not use the refrigerator 100 (for example, the user does not input a command through the menu means 23 or reset the temperature inside the refrigerating chamber or the freezing chamber), the microcomputer 50 displays the standby screen on the display means 10. Also, the microcomputer 50 reads the weather information from the storing means 30, and displays the weather information on the display means 10 with the standby screen. If the user uses the refrigerator 100, the microcomputer 50 temporarily stops displaying the standby screen or the weather information on the display means 10, and displays the user interface on the display means 10 due to the limited size of the display means 10. The control process of the microcomputer 50 in relation to the well-being indexes will now be described.

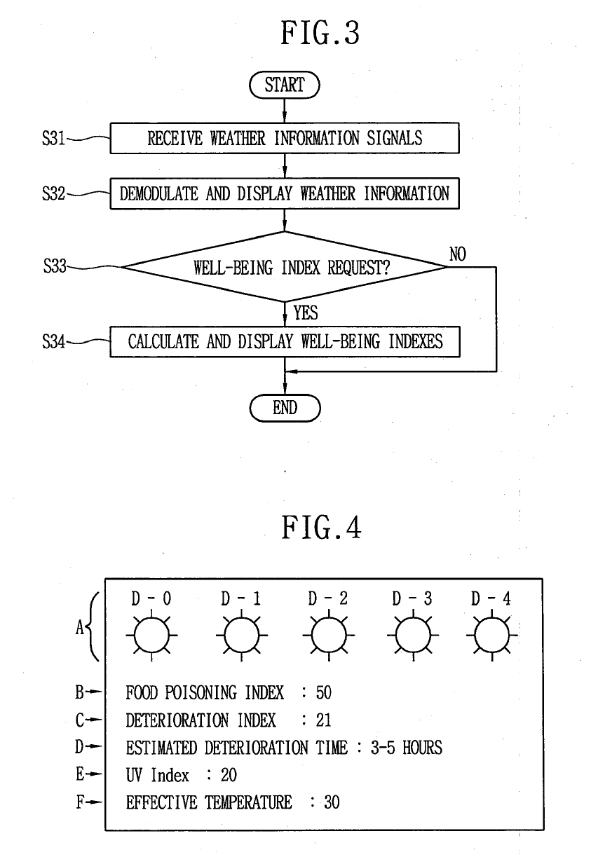

FIG. 3 is a flowchart showing the process for displaying the well-being indexes in the electric device with the wireless communication module in accordance with the present invention. The following steps are performed in a state where area code or area setting of the pager receiving module 40 has been executed.

In S31, the pager receiving module 40 receives the weather information signals through the pager network. Here, the pager receiving module 40 can receive only the weather information signals corresponding to the set area code.

In S32, the pager receiving module 40 demodulates the weather information from the weather information signals. Here, the pager receiving module 40 can demodulate only the weather information corresponding to the set area code. The step for selectively receiving or demodulating the weather information signals or the weather information corresponding to the set area code can be selectively performed in S31 or S32. Therefore, the microcomputer 50 receives the weather information from the pager receiving module 40, stores the weather information in the storing means 30, and displays the weather information on the display means 10 as shown in FIG. 2.

In S33, the microcomputer 50 reads the user request data stored in the storing means 30, and decides whether the user requests calculation and display of the well-being indexes. If the user requests calculation and display of the well-being indexes, the routine goes to S34, and if not, the routine is ended.

In S34, the microcomputer 50 calculates the well-being indexes (food poisoning index, deterioration index, etc.) by operating the weather information according to the well-being index calculation data stored in the storing means 30, stores the well-being indexes in the storing means 30, and displays the well-being indexes on the display means 10.

In S34, the microcomputer 50 can display the operated well-being indexes on the display means 10 by using characters, figures or avatars according to the above stage or degree of the well-being indexes. In case each index shows a high degree, for example, in case the estimated deterioration time is short, the microcomputer 50 notifies the degree or outputs an alarm through an audible output unit (for example, speaker) of the display means 10 in order to rapidly arouse the user's interest.

FIG. 4 is an exemplary diagram illustrating the weather information and the well-being indexes displayed on the display means 10 of FIG. 2. As depicted in FIG. 4, the microcomputer 50 can simultaneously display the weather information A, E and F and the well-being indexes B, C and D on the display means 10. As described above, the microcomputer 50 also displays characters and outputs an alarm. Such a display operation can be performed when the user presses the input means 20 or at predetermined intervals.

As discussed earlier, in accordance with the present invention, the electric device with the wireless communication module is installed in the house or office, for calculating the well-being indexes according to the weather information signals received through the pager network, and providing the well-being indexes to the user in a real time merely by using the pager receiving module.

In addition, the electric device with the wireless communication module is installed in the house or office and connected to the pager receiving module, for calculating and displaying the well-being indexes without incurring additional expenses.

Furthermore, the electric device with the wireless communication module allows the user to use its intrinsic function and rapidly obtain the well-being indexes at the same time, by calling the user's attention by visibly and/or audibly providing the well-being indexes.

Although the preferred embodiments of the present invention have been described, it is understood that the present invention should not be limited to these preferred embodiments but various changes and modifications can be made by one skilled in the art within the spirit and scope of the present invention as hereinafter claimed.

What is claimed is:

1. An electric device with a wireless communication module, comprising:
a pager receiving module for receiving weather information signals through a pager network, and demodulating weather information from the weather information signals;
a display means for displaying the weather information or well-being indexes relating to the weather information;
a storing means for storing well-being index calculation data for calculating the well-being indexes from the weather information; and
a control means for performing an intrinsic function of the electric device, receiving the weather information from the pager receiving module, reading the well-being index calculation data, calculating the well-being indexes according to the well-being index calculation data, and displaying at least one of the weather information and the well-being indexes on the display means.

2. The electric device of claim 1, wherein the well-being indexes comprise at least one of a food poisoning index, a food poisoning degree corresponding to the food poisoning index, and an estimated deterioration time.

3. The electric device of claim 1, wherein the well-being indexes comprise at least one of a deterioration index, and a deterioration degree corresponding to the deterioration index.

4. The electric device of any one of claims 1 to 3, wherein the control means divides range of the well-being indexes into a few stages, and displays the stage corresponding to the well-being indexes on the display means.

5. The electric device of claim 4, wherein the display means comprises a visible display unit and an audible output unit.

6. The electric device of claim 1, comprising a switch for selecting calculation and display of the well-being indexes, wherein the control means calculates and displays the well-being indexes according to selection of the switch.

7. The electric device of claim 1, which is an information home appliance such as a refrigerator and an air-conditioner.

8. An electric device with a wireless communication module, comprising:
a pager receiving module for receiving weather information signals through a pager network, and demodulating weather information from the weather information signals; and
a control module for controlling the electric device and displaying the state of the electric device, the control module including an operation unit for calculating well-being indexes from the weather information according to well-being index calculation data, and a display unit for displaying at least one of the weather information and the well-being indexes.

9. The electric device of claim 8, wherein the well-being indexes comprise at least one of a food poisoning index, a food poisoning degree corresponding to the food poisoning index, and an estimated deterioration time.

10. The electric device of claim 8, wherein the well-being indexes comprise at least one of a deterioration index, and a deterioration degree corresponding to the deterioration index.

11. The electric device of any one of claims 8 to 10, wherein the display unit displays the well-being indexes by stages.
